(19) United States
(12) Patent Application Publication
(10) Pub. No.: US 2004/0230564 A1
(43) Pub. Date: Nov. 18, 2004

(54) Filtering algorithm for information retrieval systems

(76) Inventors: Horatiu Simon, Heidelberg (DE); Yuh-Cherng Wu, San Jose, CA (US)

Correspondence Address: FISH & RICHARDSON, P.C., 3300 DAIN RAUSCHER PLAZA, 60 SOUTH SIXTH STREET, MINNEAPOLIS, MN, 55402, US

(21) Appl. No.: 10/439,832

(22) Filed: May 16, 2003

(51) Int. Cl. G06F 17/30

(52) U.S. Cl. 707/2

(57) ABSTRACT

Various implementations are provided herein for information classification and retrieval. In one implementation, a computer-implemented method is provided for indexing document information. The method includes obtaining textual information associated with a document, and obtaining one or more attributes associated with the document. Each attribute defines a property of the document. The method further includes generating a lexical representation of the textual information, generating one or more attribute patterns (wherein each attribute pattern contains a unique combination of the attributes), and creating a search index entry for the document. The search index entry contains the lexical representation of the textual information and each of the attribute patterns.

### TECHNICAL FIELD

This invention relates to information handling mechanisms, and more particularly to filtering algorithms for information retrieval systems.

### BACKGROUND

In today's technology age, information and information sources are plentiful. On the World Wide Web, for example, individuals are capable of accessing many sorts of information from all over the world. Database and web servers provide Internet surfers with information about fixing a car, critiquing a movie, buying products or services, and the like. By using search engines, an individual can quickly and easily locate many web sites by simply entering a series of search terms.

Search engines often provide classification and retrieval services. For example, some search engines have various “spiders” that crawl through the World Wide Web searching for web sites and web-site content. The search engine then classifies the information for these web sites, and their content, using classification and indexing schemes. A master index may be used to store references to the various web sites that have been classified. Certain classification terms may be associated with the entries stored in the master index. Then, when an individual enters one or more search terms, the search engine references its index to locate web-site references having terms that match those from the user's search request. The search engine is able to provide a list of pertinent web sites, sorted by a sort mechanism. For example, one sort mechanism may sort web sites (or “hits”) according to a ranking order, wherein the most pertinent sites are listed first.

Because of the growing amount of data on the World Wide Web, it often may be difficult for users to sort through the abundant amount of information provided by search engines. Although a user may be able to enter a series of search terms in hopes of limiting the search, the user may still be presented with hundreds, or even thousands, of “hits.” In addition, the “hits” may not be tailored to the given user. That is, if user A enters a given search request, and user B enters the same request, search engines will likely provide the same set of “hits” for both users A and B.

One way to address this issue is by providing itemized access lists. For example, meta data can be used to provide itemized information about access permissions for a given document. If a document X exists and is available on the World Wide Web, document X could have an access list associated with it (i.e., meta data) that lists all of the users who have permission to access document X. The access list could include, for example, user A and user B. If user A or user B were then to use a search engine to search for document X, the search engine would show document X as a “hit,” and these users could then access the document. If, however, any other users attempted to search for document X, the search engine would not show document X as a “hit” to these users. Although this implementation appears to have certain advantages, it also has certain drawbacks. For example, it takes time and effort to maintain the access lists associated with the document. The access lists must be kept up-to-date for each document with which they are associated, and this can become quite burdensome as users are added or removed from the system.

Another option is to maintain access lists associated with each user, wherein the access lists contain references to each document to which the given user has access. For example, an access list associated with user A could indicate that user A has permission to access document X and document Y If user A then used a search engine to search for either document X or Y, the search engine would show these documents as “hits.” If, on the other hand, user A attempted to search for other documents (which were accessible, possibly, to other users on the World Wide Web), the search engine would not show these as “hits” to user A. This implementation is beneficial because it localizes the access lists to the particular users in question. These access lists, however, suffer similar drawbacks to those described above, because it takes time and effort to maintain such lists. The lists must be kept up-to-date for each user with whom they are associated, and this can become quite burdensome as documents are added or removed from large repositories, such as the World Wide Web.

### SUMMARY

Various implementations are provided herein for information classification and retrieval. In one implementation, a computer-implemented method is provided for indexing document information. The method includes obtaining textual information associated with a document, and obtaining one or more attributes associated with the document. Each attribute defines a property of the document. The method further includes generating a lexical representation of the textual information, generating one or more attribute patterns (wherein each attribute pattern contains a unique combination of the attributes), and creating a search index entry for the document. The search index entry contains the lexical representation of the textual information and each of the attribute patterns.

In another implementation, a computer-implemented method is provided for retrieving document information. In this implementation, the method includes obtaining a search query from a user interface (wherein the search query contains textual information and a user profile having one or more profile attributes), and using the search query to obtain one or more document results from a search engine index. Each document result is associated with document textual information matching the textual information of the search query, and each document result is further associated with one or more document attributes matching the profile attributes of the user profile in the search query.

There are many advantages of certain implementations of the invention. For example, specific access lists need not be maintained. Each document in the system does not need to have an associated access list of users who are permitted to access such documents. Similarly, each user does not need to have an associated access list of specific documents to which access is permitted. Instead, general profiles having document attributes are associated with users, and these profiles determine the set of documents that are accessible to the users. The use of profiles also makes search and retrieval processing efficient. After a user enters one or more search terms, a search is conducted using the search terms and user profile, and no additional overhead is imposed on the process.

The details of one or more implementations of the invention are set forth in the accompanying drawings and the description below. Other features, objects, and advantages of the invention will be apparent from the description and drawings, and from the claims.

### DESCRIPTION OF DRAWINGS

FIG. 1A is a block diagram of a system incorporating one implementation for document classification and retrieval.

FIG. 1B is a block diagram of an implementation of the system shown in FIG. 1A.

FIG. 2A is a screen display of document, according to one implementation.

FIG. 2B is a screen display of a list of validation category entries for the document shown in FIG. 2A (according to one implementation).

FIG. 3 is a screen display of a profile, according to one implementation.

FIG. 4 is a screen display of a solution search, according to one implementation.

FIG. 5 is a screen display of a profile, according to another implementation.

FIG. 6 is a screen display of profile assignment, according to one implementation.

FIG. 7 is a screen display of an interactive solution search, according to another implementation.

FIG. 8 is a format of a pattern, according to one implementation.

### DETAILED DESCRIPTION

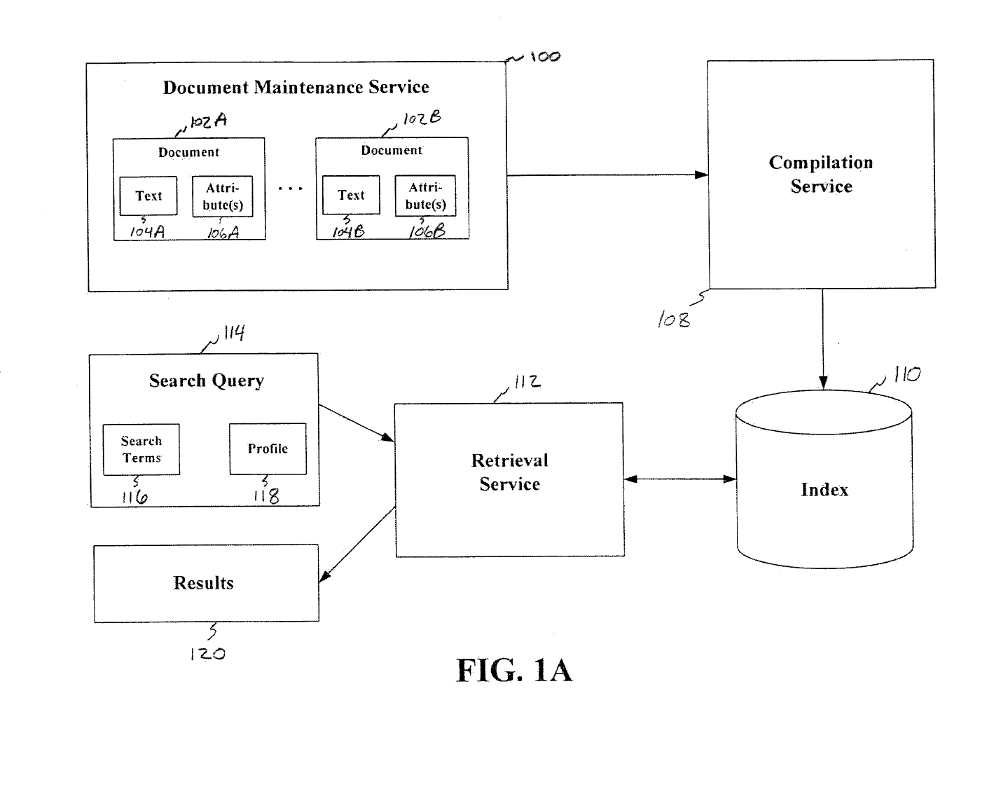

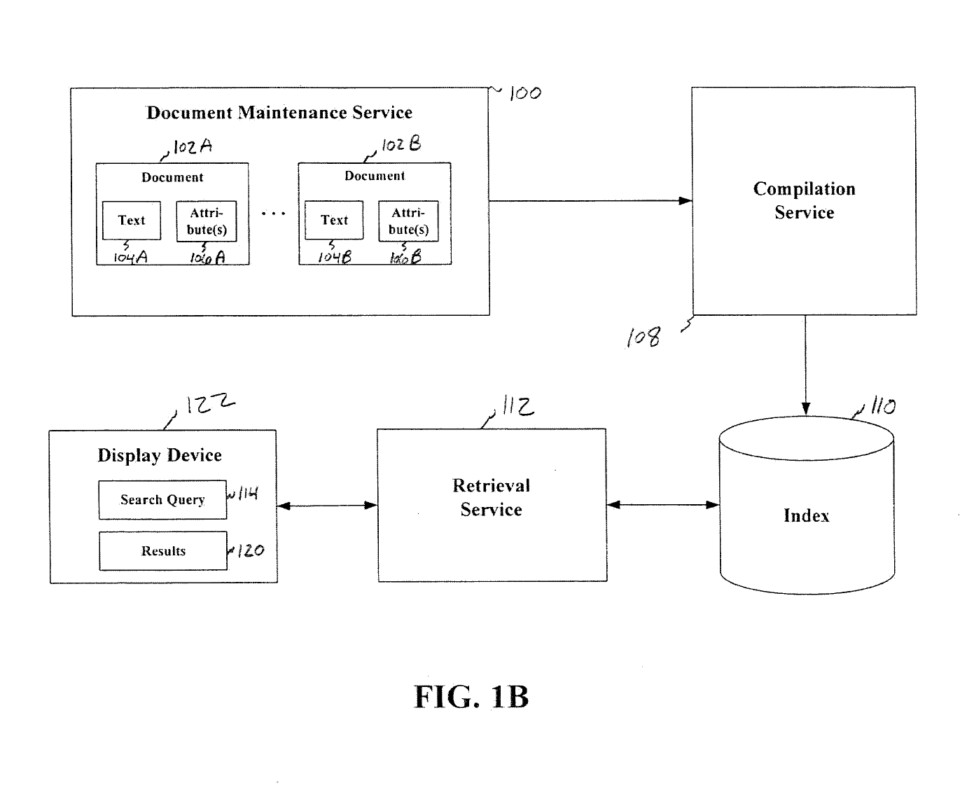

FIG. 1A is a block diagram of a system incorporating one implementation for document classification and retrieval. In this implementation, document maintenance service 100 maintains a set of source documents. These documents are then routed to compilation service 108. Compilation service 108 compiles information about the documents and stores this information in index 110. To do so, compilation service 108 may utilize various classification and/or indexing schema. Once index 110 is populated, a user may then conduct a search for documents. The user builds search query 114, which is sent to retrieval service 112. Retrieval service 112 uses search query 114 to access index 110 and obtain document results that match the query. Retrieval service 112 then sends these results 120 back to the user. In one implementation, compilation service 108, index 110, and retrieval service 112 comprise a document classification and retrieval system. In one implementation, compilation service 108, index 110, and retrieval service 112 are components of a search engine. Results 120 are filtered as per the criteria set forth in search query 114.

In FIG. 1A, document maintenance service 100 provides maintenance and/or storage capabilities for one or more documents. In one implementation, document maintenance service 100 includes one or more databases for storage of the documents. As shown in FIG. 1A, document maintenance service 100 includes documents 102A through 102B. Each of the documents, such as documents 102A and 102B, include both text and one or more attributes that are associated with the documents. Document 102A includes text 104A and attribute(s) 106A. Document 102B includes text 104B and attribute(s) 106B. The text and attributes provide information about the given document. For example, text 104A includes various textual terms, or entries, that help define the content of document 102A. In addition, attribute(s) 106A define various properties, or attributes, that are associated with document 102A. Document maintenance service 100 sends the information for all of the documents (such as documents 102A and 102b) to compilation service 108.

Compilation service 108 uses various classification and indexing schemes (or rules) to create index entries for storage in index 110. Compilation service 108 uses the text and attribute entries from the documents (such as text 104A and attribute(s) 106A) to implement its classification and indexing schemes. Compilation service 108 thereby creates index entries (for storage in index 110) for each of the input documents, such as document 102A and 102B. These index entries include as much information as necessary to identify and classify the documents, and as is stipulated by the classification and indexing scheme being implemented.

After documents have been indexed within index 110, a user may search for, and retrieve, index results for these documents. To do so, the user must create a search query, such as search query 114. Search query 114, as shown in FIG. 1A, includes search terms 116 and profile 118. Search terms 116 include one or more terms that the user has entered to define the scope of the search. Profile 118 is a profile that is associated with the user. Profile 118 may define various attributes, or properties, of documents that are to be searched. Profile 118 may also be used as a search filter. Search query 114 is sent to retrieval service 112.

Retrieval service 112 uses search query 114 when searching index 110. Retrieval service 112 retrieves from index 110 those results that match both search terms 116 and profile 118 of search query 114. Search terms 116 will be used to match corresponding entries for documents in index 110 (such as entries indexed for document text, such as text 104A or 104B). Search term 116 may include search words, and may also include search term attributes. The search terms or search attributes are used to match corresponding entries for documents in index 110. Profile 118 will be used to match properties of documents in index 110 such as properties indexed for document attributes, such as attribute(s) 106A or 106B. Profile 118 is used to help filter out various results, so that only those results having attributes matching those in profile 118 and that contain search terms 116 are retrieved. In one implementation, one or more profiles, called group profiles, may be contained within search query 114. In this implementation, the results may have attributes that match those found in either of the group profiles. Retrieval service 112 obtains results from index 110 that match search query 114, and sends these results 120 back to the user. The user can then select any of these results to access/view the pertinent document(s). In one implementation, the user obtains references to the documents (in results 120) from retrieval service 112, and accesses the documents, such as documents 102A and 102B, from document maintenance service 100 directly. For example, results 120 may include a set of Uniform Resource Locators (URL's), and when a user selects a given URL, he/she may access the actual document via document maintenance service 100, which stores the full content of such documents.

FIG. 1B is a block diagram of an implementation of the system shown in FIG. 1A. In this implementation, display device 122 displays information to a user by means of a graphical user interface (GUI). Display device 122 has the capability of providing an assortment of screen displays via the GUI (such as the various screen displays shown in subsequent figures). As shown in FIG. 1B, display device 122 is capable of displaying search query 114 and results 120. When a user wants to initiate a search, he/she may use display device 122 to create search terms 116 in search query 114. Profile 118 may also be assigned to the user by an administrator (also by using display device 122). Once a search is completed, results 120 are shown to the user on display device 122.

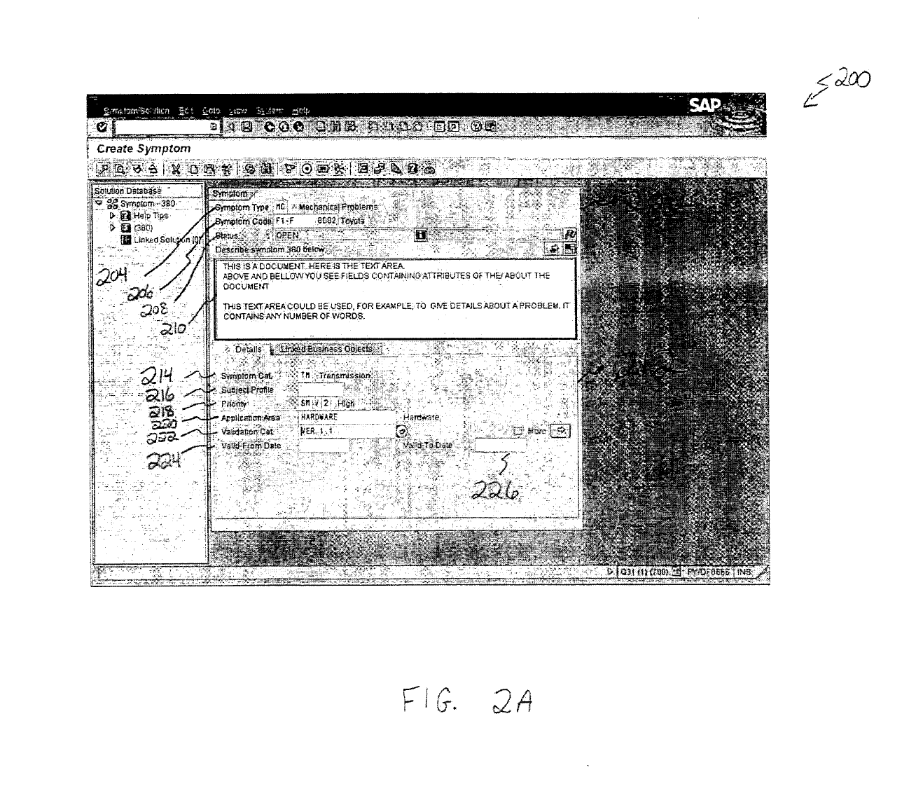

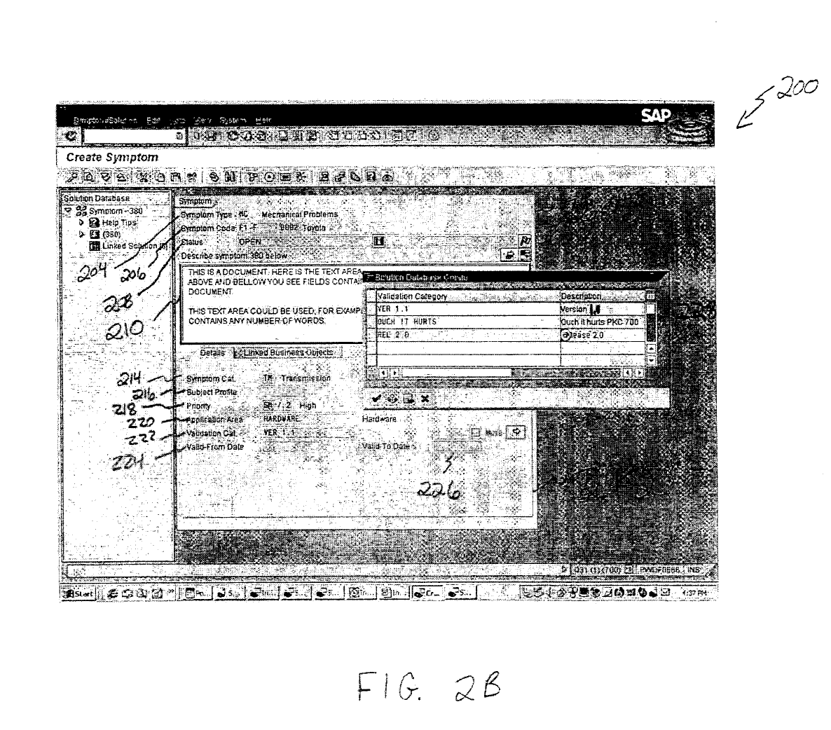

FIG. 2A is a screen display of a document, according to one implementation. In FIG. 2A, screen display 200 shows a document that has been created using a graphical user interface (GUI). In some implementations, a web browser is used to create the document. In other implementations, other GUI's are used. A user may create, or define, the document in screen area 202 using the GUI. This document (such as document 102A or 102B shown in FIG. 1A) may include both text and document properties. Once the document is defined, it can be sent to compilation service 108 for processing.

Screen area 202 contains various document attributes. In the example shown in FIG. 2A, the attributes relate to symptoms (of one or more problems), as they associate with the document being defined. In this example, the document relates to a symptom of a problem that could be used by call center agents when they are assisting customers online. Field 204 indicates a symptom type. As shown, the symptom type of “MC” corresponds to mechanical problems. Field 206 indicates a symptom code. As shown, the code “F1-F 0002” relates to Toyota. Field 208 indicates a status. As shown, the status is listed as “OPEN.” Screen area 202 also contains document text in text area 210. A user may enter document text in text area 210, as it particularly pertains to the given document. The document text may provide details about a problem/symptom, and it may contain any number of words.

Screen area 202 contains further document attributes within detail area 212. Field 214 indicates a symptom category. As shown, the symptom category of “TM” corresponds to transmission (as it relates to automobiles). Field 216 indicates a subject profile. In FIG. 2A, there is no entry for the subject profile. Field 218 indicates a priority of the document. As shown, priority “SM/2” corresponds to a high priority. Field 220 indicates an application area. As shown, the application area for this document is “HARDWARE.” Field 222 indicates a validation category. As shown, the validation category for this document is “VER 1.1.” The validation category is an addition category for the document, in addition to the symptom category stipulated in field 214. Fields 224 and 226 indicate valid from and to dates, respectively. A user may specify particular dates in these fields. As shown in FIG. 2A, no dates have been entered in fields 224 or 226.

FIG. 2B is a screen display of a list of validation category entries for the document shown in FIG. 2A (according to one implementation). FIG. 2B shows pop-up window 228, which is used for entering one or more validation categories (in the form of a list). Pop-up window 228 may appear, for example, when a user clicks on a portion of field 222, such as the icon located to the right of the “VER 1.1” text shown in field 222. Validation categories may be used to validate certain aspects of documents, such as their version number. In screen display 200 shown in FIG. 2A, only one validation category (“VER 1.1”) was entered. FIG. 2B shows a means for entering more than one validation category.

In pop-up window 228, a user is capable of entering a set of zero or more validation categories. (If there are no entries required as validation categories, then the set will be empty.) Each entry contains a validation category identifier, and a description. As shown in FIG. 2B, there are three validation categories. The first validation category is “VER 1.1,” which corresponds to Version 1.1. The next validation category is “OUCH IT HURTS,” which corresponds to PKC 700. The final listed validation category is “REL 2.0,” which corresponds to Release 2.0. The document shown in screen display 200 is associated with this list of validation categories shown in pop-up window 228. FIG. 2B shows only one example of a document attribute having a list of one or more corresponding values. Any of the other attributes shown in FIG. 2A may also have a corresponding list of values, in various implementations.

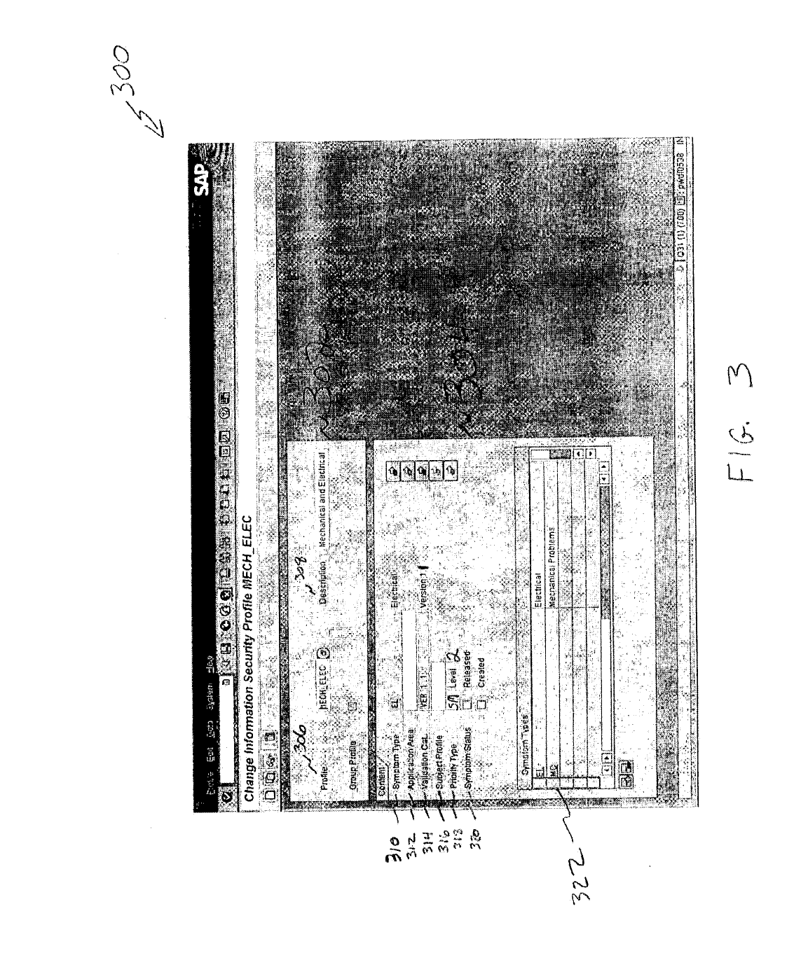

FIG. 3 is a screen display of a profile, according to one implementation. In this implementation, an individual may create a profile (such as profile 118 shown in FIG. 1A) that can be associated with one or more users in the system. After the profile is associated with a given user, it will be sent to retrieval service 112 as part of a search query, such as search query 114. The profile effectively serves as a search filter, by limiting the type of search results that are presented back to the user.

In FIG. 3, screen display 300 shows profile header area 302, and profile content area 304. An individual is able to enter or select information in profile header area 302 and profile content area 304 in defining the profile. Profile header area 302 shows the profile name (in field 306) and profile description (in field 308). As shown, the profile name in field 306 has been set to “MECH_ELEC,” with a profile description (in field 308) of “Mechanical and Electrical.” An individual may select any profile name or description as appropriate in fields 306 and 308. Profile header area 302 also shows a group profile checkbox that may be selected. If the group profile checkbox is selected, then the profile serves as a part of a group of profiles. All individual profiles that comprise a group profile may be assigned to a user. When a user who has been assigned a group profile initiates a search, the documents in the search results that are generated will contain attributes that match the attributes from at least one of the profiles in the group.

Profile content area 304 specifies various properties, or attributes, of the given profile. The properties shown in FIG. 3 demonstrates just one set of properties that can be used in a profile. Field 310 shows a property for a symptom type. In one implementation, field 310 can be set to have a list of one or more values, rather than simply a single value. Symptom type list 322, shown in FIG. 3, indicates all of the values contained within the symptom type property (of field 310). As shown, the symptom types are “EL” (Electrical) and “MC” (Mechanical). Both of these symptom types are within the scope of (and applicable to) screen display 300. Field 312 shows a property for an application area. The value inserted into field 312 (if any) is used to help identify a certain application area from which searches are narrowed. If field 312 is left blank, all application areas are included. Field 314 shows a property for a validation category. A validation category of “VER 1.1,” for Version 1.1, has been selected in FIG. 3. With this selected, only information relating to Version 1.1 would be relevant within the scope of profile in screen display 300. Field 316 shows a subject profile property. The value inserted into field 316 (if any) is used to identify a particular subject profile that can be used. Field 318 indicates the priority type. As shown in FIG. 3, the priority type is “SM” with “Level 2.” Field 320 shows a symptom status property. As shown, the symptom status is left blank. However, field 320 can be set to indicate a symptom status of “Released” and/or “Created.”

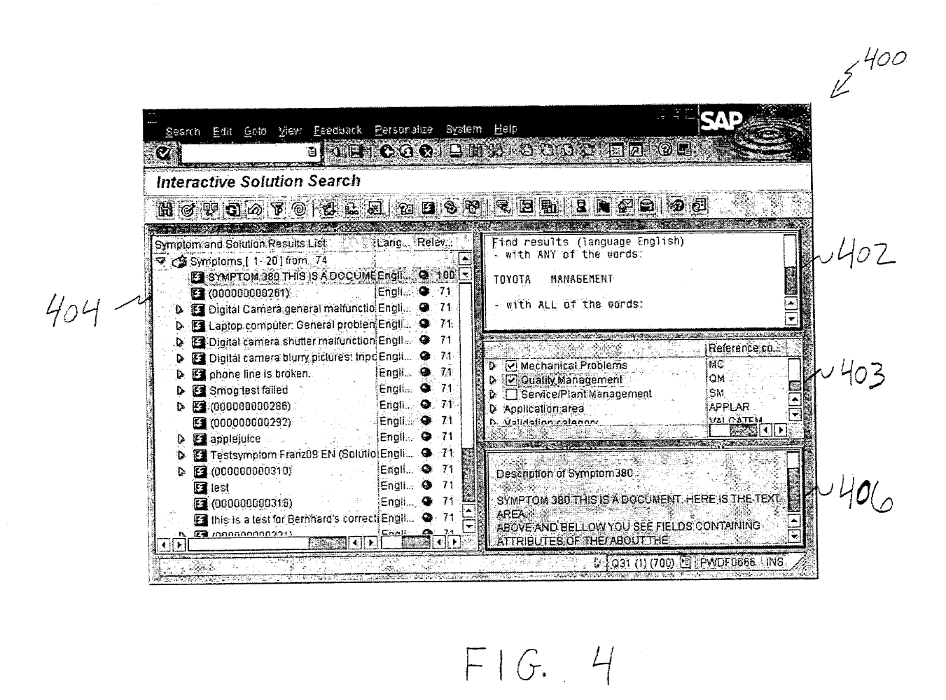

FIG. 4 is a screen display of a solution search, according to one implementation. Screen display 400 shows one implementation of an interactive solution search session. A user (such as a call center agent) is able to enter a search query for a set of potential solutions to a given problem, and is then able to view and select results. The results for potential solutions displayed can be narrowed through the contents of the search query, which can include one or more search terms.

Screen display 400 includes query area 402, attribute area 403, results area 404, and detailed description area 406. Query area 402 contains a scrolling text box. Within query area 402, a user may type in one or more search terms. In the example shown in FIG. 4, the search terms are in English, and relate to the type of search results that are requested. Other implementations support different languages and search properties. Query area 402 provides two search options: finding results that contain any of the search terms and finding results that contain all of the search terms (or words). As shown in FIG. 4, a user has chosen to search for results that contain “TOYOTA” and/or “MANAGEMENT.”

Attribute area 403 shows a set of attributes that can also be selected by a user part of a search criteria. The attributes shown in attribute area 403 correspond to symptom type attributes. Attribute area 403 may contain any variety of different types of attributes. In the example shown in FIG. 4, a user has selected the symptom type attributes of “Mechanical Problems” and “Quality Management.” By making such a selection, the user has chosen to search for either one of these attributes in addition to the search terms that were also entered into query area 402. Thus, according to the example shown in FIG. 4, the user has chosen to search for results that contain “TOYOTA” and/or “MANAGEMENT,” and that also have symptom type attributes of “Mechanical Problems” or “Quality Management.”

Results area 404 shows a set of results for the query initiated by the user in query area 402. After the user has entered various search terms in query area 402, the set of search results correlating to these search terms are displayed to the user in results area 404. These results, in one implementation, are references to documents that have been provided by a search index. As shown in FIG. 4, results area contains symptom and solution results in rank relevance (top-down) order. A total of 74 results are provided (in English, though other implementations may support alternative languages), wherein each result is shown in a separate row. A user may select any of the results, and any given selected result will be highlighted.

Detailed description area 406 shows a detailed description of a selected result. The details of the highlighted result, which has been selected in results area 404, is shown in detailed description area 406, as one example. The text shown in detailed description area 406 in FIG. 4 is shown for exemplary purposes only. The text in detailed description area 406 will generally include much more detailed information relating to a particular result.

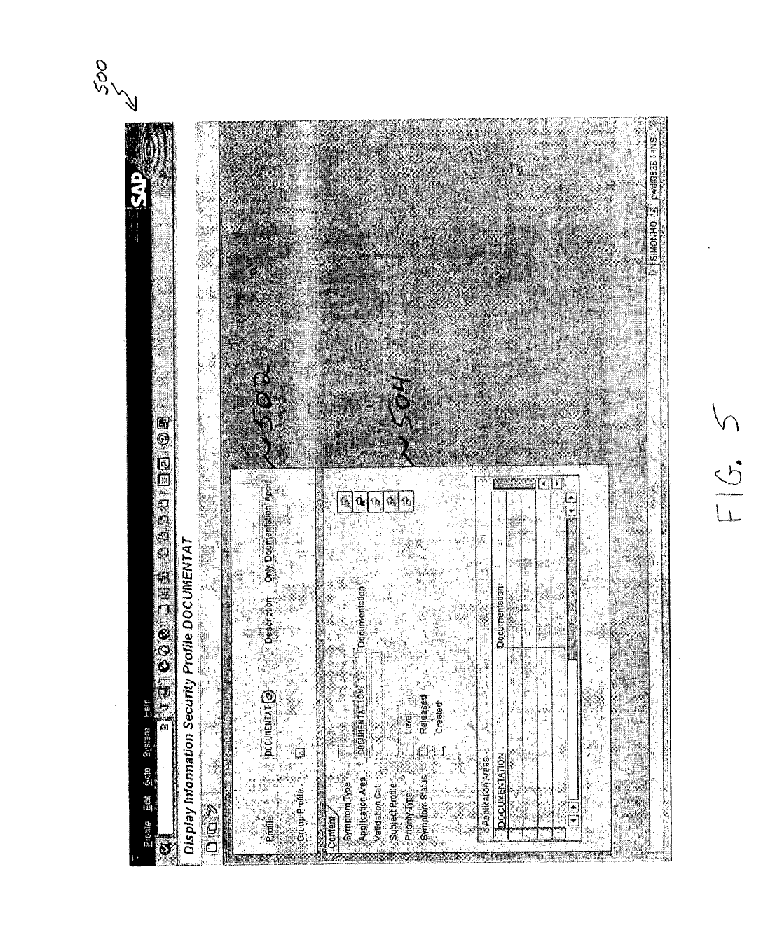

FIG. 5 is a screen display of a profile, according to another implementation. In this implementation, the security profile contains profile header area 502 and profile content area 504. A security profile has been created by populating the various fields within profile header area 502 and profile content area 504.

In profile header area 502, the profile has been named “DOCUMENTAT,” and has a description of “Only ‘Documentation’ Appl.” In profile content area 504, an application area of “DOCUMENTATION” has been selected (as the only documentation area). None of the other fields have been populated, and therefore no other requirements are mandated by the profile. In this regard, the profile shown in FIG. 5 imposes fewer filtering restrictions than the profile shown in FIG. 3. As shown, the only requirement imposed by the profile is the value of the application area attribute. The profile will only match on those documents having an application area of “DOCUMENTATION.” Profile header area 502 also shows a group profile checkbox that may be selected. If the group profile checkbox is selected, then the profile serves as a part of a group of profiles. All individual profiles that comprise a group profile may be assigned to a user. When a user who has been assigned a group profile initiates a search, the documents in the search results that are generated will contain attributes that match the attributes from at least one of the profiles in the group.

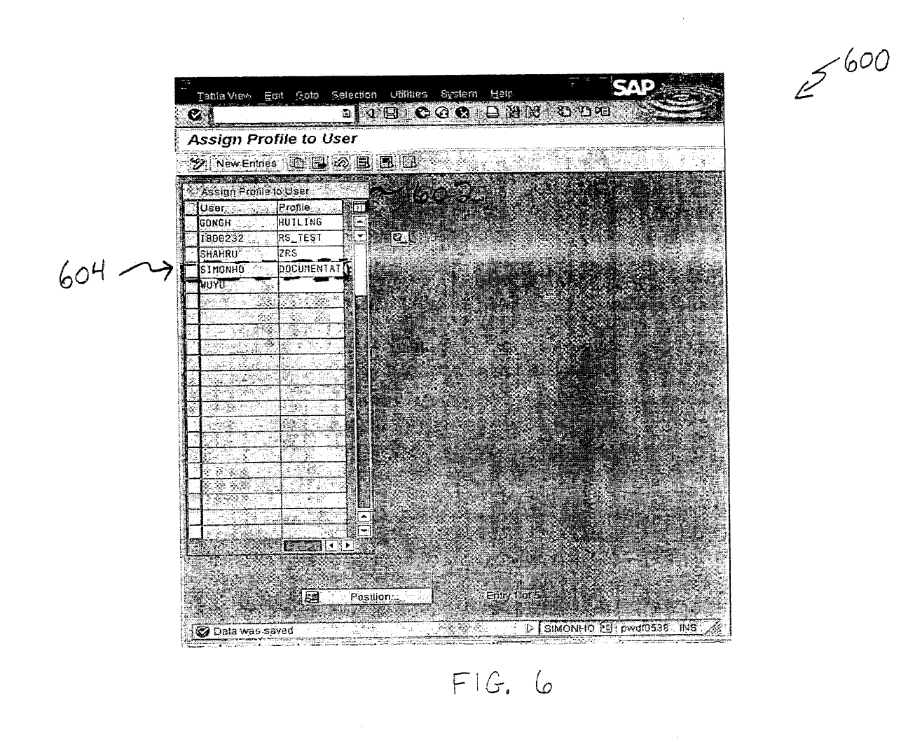

FIG. 6 is a screen display of profile assignment, according to one implementation. In this implementation, a profile (such as the one shown in FIG. 5) is assigned to one or more particular users. Once assigned, any search queries initiated by these users will contain information relating to the assigned profiles. The assigned profile may be either an individual profile or a group profile (which is associated with a set of individual profiles).

In FIG. 6, screen display 600 shows profile assignment to particular users. Assignment table 602 indicates the profile assignments to these users. Each row in assignment table 602 contains a user name (or identification), and a profile name (corresponding to the profile that is assigned to the user). A given profile may be assigned to zero or more users. Entry 604 shows that the “DOCUMENTAT” profile (shown in FIG. 5) has been assigned to the user “SIMONHO.” Therefore, after such assignment, all search requests initiated by “SIMONHO” will contain information relating to the “DOCUMENTAT” profile, which will be used during the search and retrieval process (e.g., when accessing a search index).

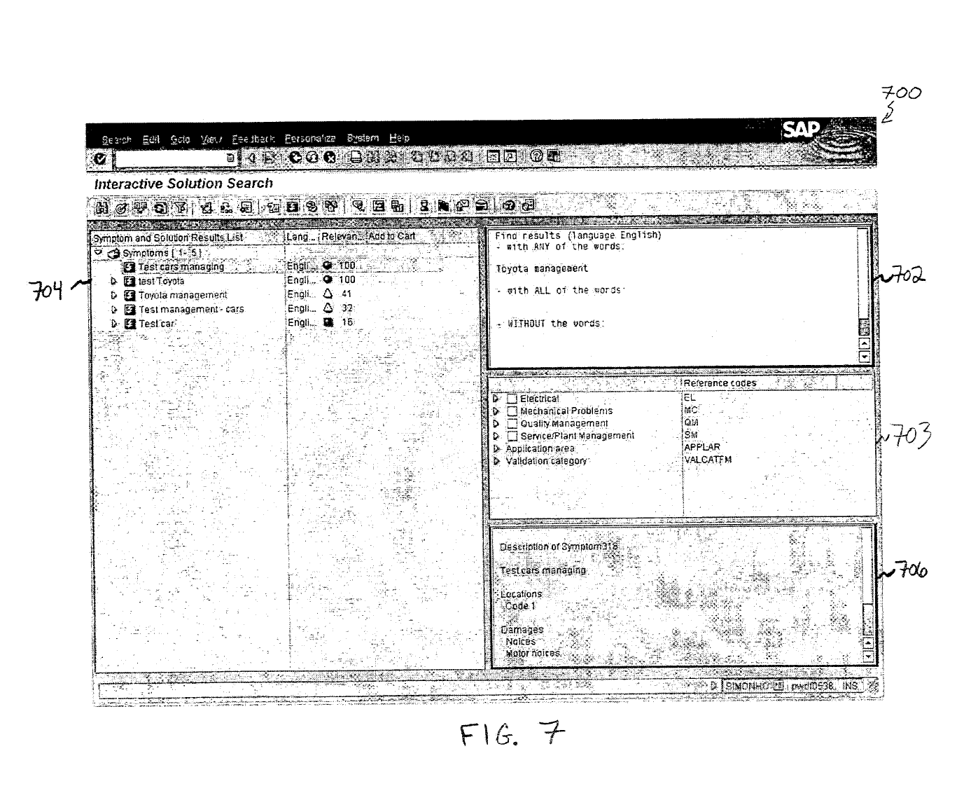

FIG. 7 is a screen display of an interactive solution search, according to another implementation. In this implementation, a user interacts with a GUI to search for solutions, using a search query containing both search terms and a user-assigned profile. In one implementation, the GUI comprises a web-enabled browser. A set of results is displayed to the user that match both the search terms and the criteria set forth in the user-assigned profile (which may be comprised of attributes, properties, and the like). Because of the use of the user-assigned profile as a filtering mechanism, the set of results shown in FIG. 7 is smaller than the set shown in FIG. 4.

Screen display 700 includes query area 702, attribute area 703, results area 704, and detailed description area 706. Query area 702 includes a text box, within which a user may enter one or more search terms. The user may specify a search containing any or all of the entered search words. Attribute area 703 shows a set of attributes that can also be selected by a user part of a search criteria. The specific attributes shown in attribute area 703 correspond to symptom type attributes. Attribute area 703 may also contain any variety of different types of attributes, such as application area attributes or validation category attributes. Attributes selected in attribute area 703 may be used in conjunction with the terms entered in query area 702 to form the basis for a user's search query.

Results area 704 shows a list of symptom and solution results that have been found (shown in English) in top-down rank order. Each result is shown in a given row, and can be selected by the user. Only those results containing one or more of the terms “Toyota” or “management,” and also matching the attributes of the profile assigned to the user requesting search results, are displayed in results area 704. If the user “SIMONHO,” for example, had initiated the search by entering the terms shown in query area 702, and if the profile “DOCUMENTAT” had been assigned to this user (as shown in FIG. 6), then only those results containing one or more of the terms “Toyota” or “management,” and also having an application area of “DOCUMENTATION” will be displayed in results area 704. (The application area of “DOCUMENTATION” is stipulated in the definition of this profile, as shown in FIG. 5).

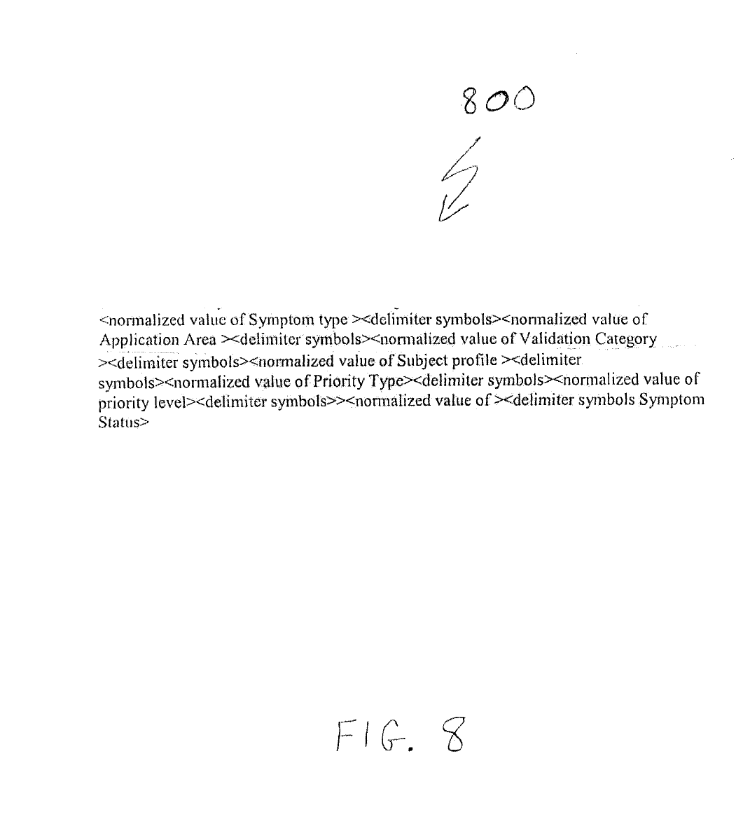

FIG. 8 is a format of a pattern, according to one implementation. Format 800 indicates one form of pattern that may be used to implement a user profile and/or document attributes that are used during the indexing, search, or retrieval processes. For example, in one implementation, document maintenance service 100 (shown in FIG. 1A) could generate one or more document attribute patterns, using format 800, from document attributes 106A or 106B. In this implementation, index 110 stores information relating to these various patterns. In one implementation, search query 114 can generate one or more profile patterns (using format 800) from profile 118. In these implementations, document information can be compiled and classified in index 110 for later retrieval by a user who has initiated a search query (such as search query 114, shown in FIG. 1A).

The attributes that are included within format 800 are symptom type, application area, validation category, subject profile, priority type, priority level, and symptom status. The normalized values of the attributes are included in the format (normalized indicating that there are no spaces, and all letters appear in the same case). In other implementations, normalization may not be required to achieve similar functionality. If no normalized value is specified for a given attribute, a ‘*’ wildcard character can be used to indicate any (or all) values of that attribute are applicable (or can be matched).

Delimiter symbols separate each normalized value of the individual attributes shown in format 800. The delimiter symbols may include one or more characters that usually do not appear in the identifier of the attributes (e.g., two semicolons ‘;;’).

Generating Patterns to Describe a User Profile

Using format 800, patterns can be generated to describe a user profile. (For example, search query 114, shown in FIG. 1A, or a search system may be used to generate one or more user profile patterns having format 800, using profile 118 as input.) For profiles, all patterns result from the combination of the attribute value lists, according to one implementation. As an example, let's presume for a moment that a profile “MECH_ELEC” is defined (similar to the one shown in FIG. 3). This profile includes a list of two symptom types (“EL” and “MC”), a validation category (“VER 1.1”), and a priority level “2” of type “SM.” Using format 800, the following two patterns would be generated for Profile “MECH_ELEC”:

el;;*;;ver1.1;;*;;sm;;2;;*

mc;;*;;ver1.1;;*;;sm;;2;;*

These two patterns contain a unique combination of the specified attribute values. Although the validation categories, priority levels and types are the same, the two different symptom types of “el” and “mc” provide uniqueness to each combination. The placeholder “ ” between the delimiter symbols “;;” stand for attributes that are not specified in the profile definition (such as application area, subject profile and symptom status). The “*” indicates that any values can be matched for these attributes.

Generating Patterns to Describe a Document

Using format 800, patterns can also be generated to describe a document. (For example, document maintenance service 100, shown in FIG. 1A, may be used to generate one or more document attribute patterns having format 800, using attributes 106A and/or 106B as input.) The pattern generation for document attributes (such as symptoms) includes certain steps.

At the beginning, the same patterns as those for profiles are generated (by combining all populated attributes of the document). For example, in the document shown in FIG. 2B, the initial set of patterns would be:

mc;;hardware;;ver1.1;;*;;sm;;2;;open

mc;;hardware;;ouchithurts;;*;;sm;;2;;open

mc;;hardware;;rel2.0;;*;;sm;;2;;open

The placeholder “*” indicates that there is an unpopulated ‘Subject profile’ field. There are 3 patterns generated in this first phase, as the document has 3 validation categories associated with it. Any of these first three patterns may be matched during the search/retrieval process by a pattern generated from a user profile. For example, retrieval service 112 (shown in FIG. 1A) generates profile patterns from profile 118. If any of these profile patterns match any of the patterns above, then the document reference is retrieved from index 110 and returned to the user in results 120.

In the second phase, another fifteen different patterns are generated by taking each of the three patterns from the first phase and replacing a specified normalized attribute value with a “*”. For example, from “mc;;hardware;;ver1.1;;*;;sm;;2;;open” the following patterns are generated (wherein one implementation, the priority type and level are coupled):

*;;hardware;;ver1.1;;*;;sm;;2;;open

mc;;*;;ver1.1;;*;;sm;;2;;open

mc;;hardware;;*;;*;;sm;;2;;open

mc;;hardware;;ver1.1;;*;;*;;*;;open

mc;;hardware;;ver1.1;;*;;sm;;2;;*

These patterns contain fewer specific attributes than those specified in the original document. During the search/retrieval process, a pattern generated from a user profile (such as profile 118) may contain a fewer number of attributes than specified in the original document, but would still match one of the patterns shown above. As long as the user profile specifies a subset of attributes in the original document (such as those shown above), a match should be generated.

In the third phase, additional patterns are generated by taking each of the patterns generated during the second phase and replacing another specified normalized attribute value with a ‘*’. This algorithm is repeated until the patterns generated have one specified attribute and 5 attributes replaced by ‘*’ wildcards. These last generated patterns are:

mc;;*;;*;;*;;*;;*;;*

*;;hardware;;*;;*;;*;;*;;*

*;;*;;ver1.1;;*;;*;;*;;*

*;;*;;ouchithurts;;*;;*;;*;;*

*;;*;;rel2.0;;*;;*;;*;;*

*;;*;;*;;*;;sm;;2;;*

*;;*;;*;;*;;*;;*;;open

All of these generated patterns are used to describe the document. The full set of patterns are those generated during the first, second, and third phases of pattern generation.

Pattern Usage

During the indexing and compilation process, compilation service 108 (according to one implementation), as shown in FIG. 1A, obtains the text of a document (such as document 102A and 102B) as a string of characters and generates (as output) entries to be stored in index 110. Index 110 is a (lexical) description of the documents. Index 110 is then used by retrieval service 112 to generate a hit list (e.g., in results 12) matching a user query specified by search query 114 (in one implementation).

The patterns generated from document attributes (such as attributes 106A or 106B) are attached to the document text (such as text 104A or 104B) and sent to compilation service 108. In one implementation, compilation service 108 (along with index 110 and retrieval service 112) are part of a search engine. Thus, using an example of the document shown in FIG. 2B (including its text and attributes), the following information would be sent to compilation service 108:

“SYMPTOM 380 THIS IS A DOCUMENT. HERE IS THE TEXT AREA. ABOVE AND BELLOW YOU SEE FIELDS CONTAINING ATTRIBUTES OF THE/ABOUT THE DOCUMENT. THIS TEXT AREA COULD BE USED, FOR EXAMPLE, TO GIVE DETAILS ABOUT A PROBLEM. IT CONTAINS ANY NUMBER OF WORDS.

mc;;hardware;;ver1.1;;*;;sm;;2;;open

mc;;hardware;;ouchithurts;;*;;sm;;2;;open

mc;;hardware;;rel2.0;;*;;sm;;2;;open

*;;hardware;;ver1.1;;*;;sm;;2;;open

mc;;*;;ver1.1;;*;;sm;;2;;open

mc;;hardware;;*;;*;;sm;;2;;open

mc;;hardware;;ver1.1;;*;;*;;*;;open

mc;;hardware;;ver1.1;;*;;sm;;2;;*

[ . . . ]

mc;;*;;*;;*;;*;;*;;*

*;;hardware;;*;;*;;*;;*;;*

*;;*;;ver1.1;;*;;*;;*;;*

*;;*;;ouchithurts;;*;;*;;*;;*

*;;*;;rel2.0;;*;;*;;*;;*

During the search and retrieval process, profile patterns (from profile 118 shown in FIG. 1A, according to one implementation) are generated from search query 114. The patterns generated are added at runtime to search terms 116 and sent to retrieval service 112. The search information sent to retrieval service 112 has the following form (in one implementation):

(Query as formulated by search terms 116) AND (<pattern 1 generated from profile 118> OR <pattern 2 generated from profile 118> OR . . . <pattern N generated from profile 118>)

In one implementation, patterns 1 . . . N are generated from profile 118, and each of these patterns have formats corresponding to format 800. These patterns along with the query of search terms are sent to retrieval service 112.

As an example, a user could enter search terms for “Toyota” or “Management,” similar to that shown in FIG. 4. In addition, the user (in this example) has been assigned the “MECH_ELEC” profile (as shown in FIG. 3). In this case, the query send to retrieval service 112 is:

(“Toyota” OR “management”) AND (el;;*;;ver1.1;;*;;sm;;2;;* OR mc;;*;;ver1.1;;*;;sm;;2;;*)

Retrieval service 112 then accesses index 110 to search for matches. Matches are returned to the user in results 120 (which are displayed to the user in a GUI, according to one implementation). In this fashion, the user sees only those documents (or document references) that simultaneously match (satisfy) the query of search terms (such as search terms 116) and are part of the profile (such as profile 118) associated with the user.

A number of implementations of the invention have been described. Nevertheless, it will be understood that various modifications may be made without departing from the spirit and scope of the invention. Accordingly, other implementations are within the scope of the following claims.

What is claimed is:

1. A computer-implemented method for indexing document information, the method comprising:
obtaining textual information associated with a document;
obtaining one or more attributes associated with the document, each attribute defining a property of the document;
generating a lexical representation of the textual information;
generating one or more attribute patterns, each attribute pattern containing a unique combination of the attributes; and
creating a search index entry for the document, the search index entry containing the lexical representation of the textual information and each of the attribute patterns.

2. The computer-implemented method of claim 1, wherein obtaining one or more attributes associated with the document includes obtaining one or more attributes that are selected from a group consisting of a symptom type attribute, an application area attribute, a validation category attribute, a subject profile attribute, a priority type attribute, a priority level attribute, and a symptom status attribute.

3. The computer-implemented method of claim 1, wherein obtaining one or more attributes associated with the document includes obtaining one or more attributes from an attribute list.

4. The computer-implemented method of claim 1, wherein generating one or more attribute patterns includes generating one or more attribute patterns that each have one or more normalized attribute values.

5. The computer-implemented method of claim 1, wherein generating one or more attribute patterns includes generating one or more attribute patterns that each have a plurality of attribute values separated by one or more delimiters.

6. The computer-implemented method of claim 1, wherein generating one or more attribute patterns includes generating one or more attribute patterns that contain a wildcard placeholder for an attribute value.

7. The computer-implemented method of claim 1, wherein generating a lexical representation of the textual information includes generating one or more textual entries to represent the textual information.

8. The computer-implemented method of claim 1, wherein the method further comprises storing the search index entry in a search engine index.

9. A computer-implemented method for retrieving document information, the method comprising:
obtaining a search query from a user interface, the search query containing textual information and a user profile having one or more profile attributes; and
using the search query to obtain one or more document results from a search engine index, wherein each document result is associated with document textual information matching the textual information of the search query, and wherein each document result is further associated with one or more document attributes matching the profile attributes of the user profile in the search query.

10. The computer-implemented method of claim 9, wherein the user profile contains one or more profile attribute patterns, each profile attribute pattern containing a unique combination of the profile attributes.

11. The computer-implemented method of claim 10, wherein each document result is associated with a document attribute pattern that matches a profile attribute pattern of the user profile, and wherein the document attribute pattern contains a unique combination of the document attributes.

12. The computer-implemented method of claim 10, wherein one or more of the profile attribute patterns contain a plurality of profile attribute values separated by one or more delimiters.

13. The computer-implemented method of claim 10, wherein one or more of the profile attribute patterns contain a wildcard placeholder for a profile attribute value.

14. The computer-implemented method of claim 9, wherein the user profile contains one or more attributes from an attribute list.

15. The computer-implemented method of claim 9, wherein the search query further contains a second user profile having one or more profile attributes; and wherein each document result is associated with one or more document attributes matching the profile attributes of either the user profile or the second user profile.

16. The computer-implemented method of claim 9, wherein the method further comprises sending the document results to the user interface for display purposes.

17. The computer-implemented method of claim 9, wherein the textual information of the search query contains one or more textual entries, and wherein the document textual information contains one or more textual entries.

18. A computerized system for indexing document information, wherein the system is programmed to:
obtain textual information associated with a document;
obtain one or more attributes associated with the document, each attribute defining a property of the document;
generate a lexical representation of the textual information;
generate one or more attribute patterns, each attribute pattern containing a unique combination of the attributes; and
create a search index entry for the document, the search index entry containing the lexical representation of the textual information and each of the attribute patterns.

19. A computerized system for retrieving document information, wherein the system is programmed to:
obtain a search query from a user interface, the search query containing textual information and a user profile having one or more profile attributes; and
use the search query to obtain one or more document results from a search engine index, wherein each document result is associated with document textual information matching the textual information of the search query, and wherein each document result is further associated with one or more document attributes matching the profile attributes of the user profile in the search query.

20. A computer-readable medium having computer-executable instructions thereon for performing a method, the method comprising:
obtaining textual information associated with a document;
obtaining one or more attributes associated with the document, each attribute defining a property of the document;
generating a lexical representation of the textual information;
generating one or more attribute patterns, each attribute pattern containing a unique combination of the attributes; and
creating a search index entry for the document, the search index entry containing the lexical representation of the textual information and each of the attribute patterns.

21. A computer-readable medium having computer-executable instructions thereon for performing a method, the method comprising:
obtaining a search query from a user interface, the search query containing textual information and a user profile having one or more profile attributes; and
using the search query to obtain one or more document results from a search engine index, wherein each document result is associated with document textual information matching the textual information of the search query, and wherein each document result is further associated with one or more document attributes matching the profile attributes of the user profile in the search query.
